(19) United States
(12) Patent Application Publication
(10) Pub. No.: US 2009/0070693 A1
(43) Pub. Date: Mar. 12, 2009

(54) Technique for individualizing content

(75) Inventors: Linda Allan Mosquera, Andover, MA (US); Carmin J. Moutinho, III, Ludlow, MA (US)

Correspondence Address: GORDON E NELSON;PATENT ATTORNEY, PC, 57 CENTRAL ST, PO BOX 782, ROWLEY, MA, 01969, US

(73) Assignee: Individuate, Inc, Andover, MA (US)

(21) Appl. No.: 12/205,707

(22) Filed: Sep. 5, 2008

Related U.S. Application Data
(60) Provisional application No. 60/970,305, filed on Sep. 6, 2007.

(51) Int. Cl. G06F 3/048

(52) U.S. Cl. 715/764

(57) ABSTRACT

Techniques which permit content developers with no programming skills to develop multi-versioned individualized content. The techniques include GUIs which permit the content developers to insert tags into the content without knowledge of tag syntax or of the syntax of rules for specifying conditional insertion. There are two GUIs, one for tags which specify positions at which personal information of a recipient is to be inserted into the content, and one for inserting tags for content that is specific to a particular version of the content. Once the GUI for the version tags specifies a version, ordinary editing operations on the content result in the production of the version tags. The GUIS further permit the content developer to specify generation of displays which show content which is shared by all of the versions, a particular version of the content, and a particular recipient's version.

### CROSS-REFERENCE TO RELATED APPLICATIONS

This application claims priority from U.S. Provisional Patent Application 60/970,305, Mosquera, et al:, Tool for specifying the contents of variable portions of a document, filed Sep. 6, 2007.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The invention concerns creation and delivery of information generally and more particularly concerns systems which allow users to create output in which the information is tailored to the recipient. Such output is termed in the following individualized content and the process of producing individualized content is termed content individualization.

2. Description of Related Art

A common problem presented to content creators today is the creation of content that is highly individualized for a specific recipient. As technologies have evolved, so have the requirements of companies to have finer and more accurate individualization with increasing amounts of variability.

FIG. 1 is a high-level block diagram of a prior-art system 101 for creating individualized content. System 101 uses information 109 about a recipient of individualized information and information items 107 from an information item database 105 to produce an instance 111 of individualized content for the recipient. Instance 111 may, for example, be a letter which the recipient will receive through the mail or a Web page which will appear on the recipient's browser. The behavior of system 101 is determined by information assembly program 103, which uses rules created manually together with recipient info 109 to determine which of the items in info item database should be included in individualized instance 111 and then makes personalized output info 111 using the selected information items 107. If the data for a recipient included the recipient's annual income in a record column called INCOME, the user might create a rule that specified that the personalized output info use the recipient's given name in the salutation if INCOME<100000 and otherwise use the recipient's surname.

Examples of available systems which work like system 101 include Variable Defined Printing (VDP) programs that work together with design layout programs to produce printed material such as direct mail pieces and brochures and Personal URL (PURL) programs which are employed in Web servers for Web-based marketing. Specific commercially available VDP programs include Fusion Pro by Printable Technologies, XMPie sold by Xerox and Darwin sold by Kodak. Commercially available PURL programs include Look Who's Clicking by Mindfire and Easy PURL by Indros Group.

The advent of VDP or Variable Defined Printing was a huge leap forward for content developers. VDP tools removed much of the complexity around the creation of variable content. VDP added rules for determining what content was to be altered in the individualization process and permitted alteration of larger chunks of content, and this in turn permitted much more specialized and individualized content creation. VDP tools also allowed for connections with relational databases that contained the data used in individualization, allowing larger, more complex, data sets to be managed more easily. Because much of the complexity of individualized content creation was removed, costs of creating individualized content were reduced and the individualized content could be created by content developers rather than programmers.

While significantly more powerful than standard content individualization tools, VDP and PURL still have limitations that reduce their usefulness for content developers:
A content developer has to know the special syntax used to indicate in the content being individualized where in the content an alteration that is part of an individualization is to be included and what the alterations are;
The use of content-developer written rules requires that the content developer have a working knowledge of Boolean logic and of the syntax for the rules;
Databases are designed and maintained by programmers and kept rigid in terms of what data is available to the content creators;
Keeping track of more than a few rules and items of variable content quickly becomes complex and difficult; and
Defining variable content in terms of items of variable content and rules governing when the variable content is to be used forces content creators to think like programmers.

What is needed, therefore, is techniques which make it possible for ordinary content developers to individualize content as easily as they presently make and modify documents or presentations generally. It is an object of the present invention to provide such techniques.

### BRIEF SUMMARY OF THE INVENTION

In one aspect, the techniques disclosed herein attain the object by providing a method of making a tag for an individualization data item which requires no knowledge of tag syntax. The method is p-practiced in a content individualization system which has a content editing GUI and a tag making GUI. The method includes the steps performed by a user of the content individualization system of
using the content editing GUI to navigate to the location in the content; and
using the tag making GUI to identify the individualization data; and
   the step performed by the content individualization system in response to the user steps of
creating the tag that represents the identified individualization data at the location in the content.

In another aspect, the techniques attain the object by providing a method that is employed with content that has more than one version of editing a particular version using a content processor. The method includes the steps performed in the content processor of:
responding to a selection in a version selection GUI of a set of values which distinguish the particular version and input specifying an editing operation on the content; and
associating data resulting from the editing operation with the distinguished particular version.

In a further aspect, the techniques attain the object by providing a method of displaying content that has more than one version and has base content that is included in all of the versions. The method includes the steps of:
when user input to a GUI indicates the base content, displaying the base content; and
when user input to a GUI indicates one of the versions, displaying the version with the included base content.

In a still further aspect, the techniques attain the object by providing a representation of content which includes version content for more than one version. The representation includes a representation of the common content. In the representation of common content, there is a distinct set of version tags for each of the versions. A version tag that represents an item of version data belonging to a particular version is located in the representation of the content where the represented item of version data is to be inserted. The version tag further includes a version identifier that identifies the particular version and an item of version data identifier that identifies a source for the represented version data item which is external to the representation of the content.

Other objects and advantages will be apparent to those skilled in the arts to which the invention pertains upon perusal of the following Detailed Description and drawing, wherein:

### BRIEF DESCRIPTION OF THE SEVERAL VIEWS OF THE DRAWINGS

FIG. 1 is a block diagram of a prior-art system for producing individualized output information;

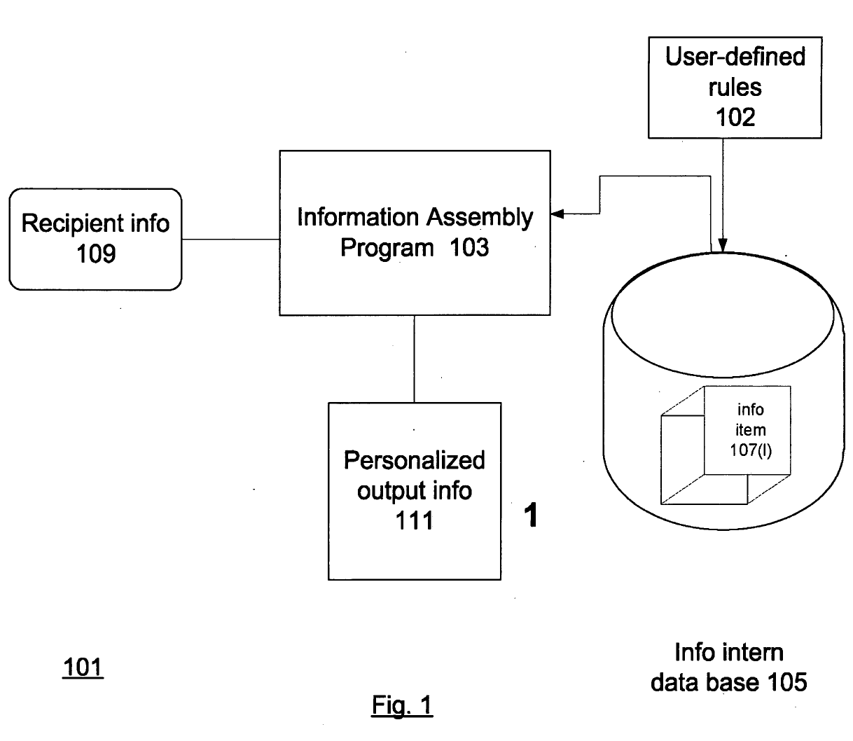

FIG. 2 is an example editing scenario for a presently-preferred embodiment of the disclosed system for producing individualized content;

FIG. 3 is a block diagram of the presently-preferred embodiment of the system for producing individualized output;

FIG. 4 shows version data GUI 807 in the presently-preferred embodiment;

FIG. 5 shows instance data GUI 809 in the presently-preferred embodiment;

FIG. 6 is a sample XML file which defines the settings and labels in individualization GUI 811 in the presently-preferred embodiment;

FIG. 7 shows details of the tags 835 and individualization information 822 in the presently-preferred embodiment; and

FIG. 8 is an overview of a content individualization system which incorporates the techniques disclosed herein.

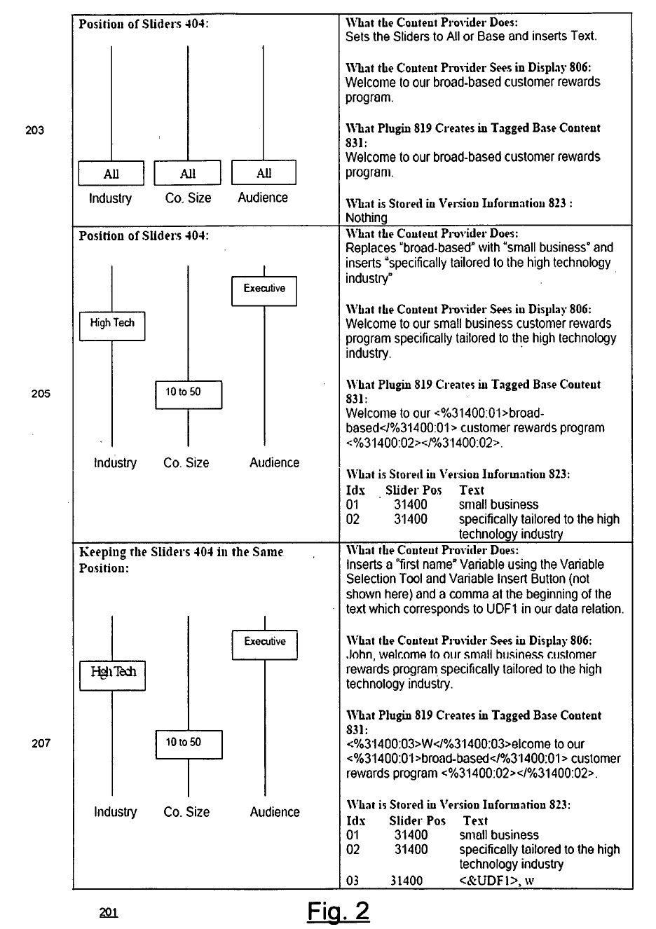

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION OF THE INVENTION

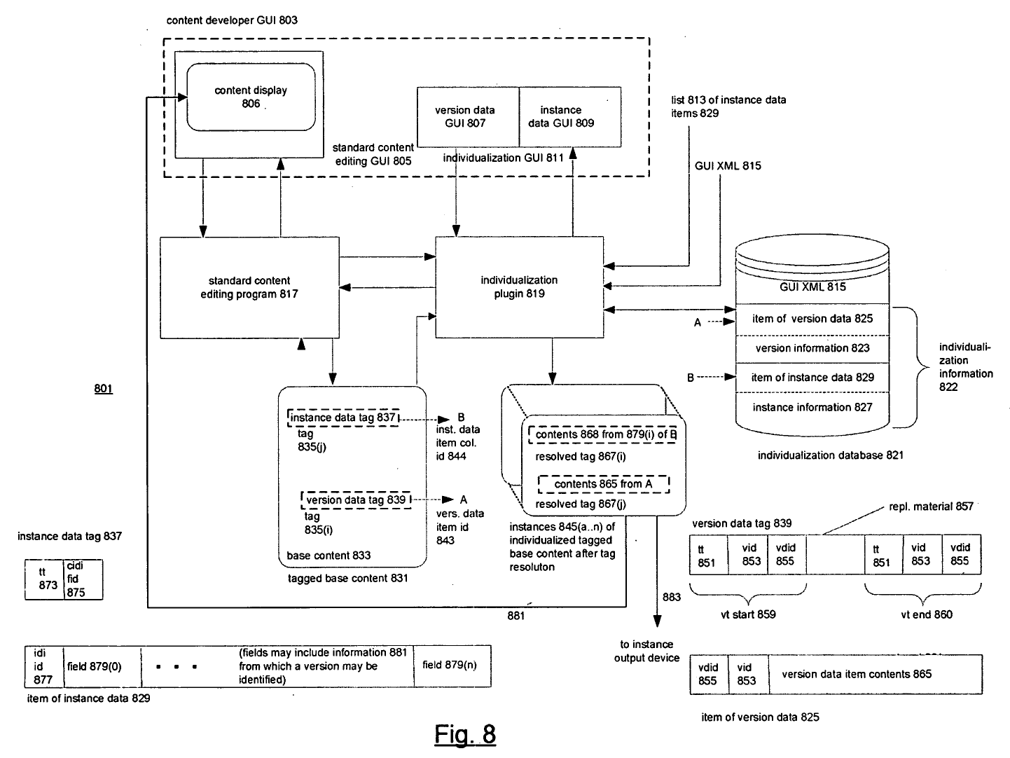

Overview of the Individualization Techniques: FIG. 8

FIG. 8 is a logical block diagram of a system 801 in which the individualization techniques have been implemented. The chief components include a standard commercial content editing program 817 with its graphical user interface 805, which includes content display 806 in which the content being edited is displayed, an individualization plugin 819 for editing program 817, a graphical user interface 811 for plugin 819, and an individualization database 821 which contains the XML 815 needed to implement plugin GUI 811 and individualization information 822 required for producing individualized content. Content-editing program 817 may be a content editing program for any kind of medium, for example, a document editor, a Web publisher, or a presentation maker.

The content to be individualized is base content 833, which is contained in an entity such as a document produced by editing program 817. Individualization is done by adding tags 835 to base content 831 which represent items of individualization information in database 821. Instances of the individualized content are shown at 845. Plugin 819 produces the instances 845 by replacing tags 835 with the individualization information items which the tags represent.

The relationship between plugin 819 and editing program 817 is the following: when a content provider is working on tagged base content 831, individualization plugin 819 intercepts every keystroke made by the content provider in content editing GUI 805. Depending on the sequence of keystrokes and their context in GUI 817 and in GUI 811, individualization plugin 819 may do any of the following:
nothing;
insert a tag 835 representing an item of individualization information 822 into base content 831;
both insert a tag and make an item of individualization information for the tag in individualization data base 821;
cause tagged base content 831 to be displayed in content display 806 in any of three ways:
   1. without tags 835, which results in base content 833 being displayed.
   2. with tags 835 for a particular version of tagged base content 831 being resolved, which results in the display of that version of tagged base content 831 being displayed.
   3. with all tags 835 being resolved, which results in the display of an individualization instance 845.

It should be noted here that in some embodiments, plugin 819 may be implemented as a component of standard content editing program 817. An advantage of the implementation as a plugin is that the same individualization GUI 811 may be used with editors for a variety of different kinds of content.

A noteworthy aspect of individualization information 822 is that there are two classes of information 822: version information 823 and instance information 827.
Version information 823 is information which defines different versions of base content 833; in many applications of the techniques, the different versions are related to different groups of recipients for the instances 845. For example, if the content is promotional material, there may be different versions of base content 833 for recipients working for large high-tech companies and those working for small high-tech companies.
Instance information 827 is information which varies in each instance of individualized content produced by system 801. Examples of this kind of information are the name and address of the recipient of a specific instance of the content, the URL of a browser from which a request for information has been received, or the information which relates the recipient to a group.

Corresponding to the two kinds of individualization information are two GUIs in individualization GUI 811:
a version data GUI 807 for indicating what items 825 of version information 823 are to be placed in tagged base content 831 and where the items 825 are to be placed in the tagged base content; and
an instance data GUI 809 for indicating which instance data items 829 are to be placed in a given individualized content instance 845 and where these data items are to be placed in tagged base content 831.

As is apparent from the foregoing, in system 801, the items of individualization information in database 821 must be related to locations in base content 833. This done by means of tags 835 which the user of individualization GUI 811 inserts into base content 833 at the locations where the items of individualization information are to appear. The tags are invisible to the user of GUI 811 and are not included in instances 845.

There are two kinds of tags 835, corresponding to the kinds of individualization information: instance data tag 837, which marks a location in tagged base content 833 into which an item of instance data is inserted when an instance 845 is produced, and version data tag 839, which marks a location in tagged base content 831 into which an item of version data 825 is inserted. Both kinds of tags 835 contain information from which the item of individualization info to be inserted can be located in individualization database 821.

Continuing with details of the tags 835 and the items of data in individualization database 821 that the tags refer to, an instance data tag 837 contains two items of information: a tag type (tt) 837, indicating that it is an instance data tag, and a field identifier 875 indicating the field in the item of instance data 829 being used to individualize the current instance 845 from which the data to be inserted into the instance 845 at the tag location is to be taken. The contents of an item of instance data 829 include an identifier 877 which permits location of the item of instance data in instance information 827 and a number of fields 879 (0 . . . n) which contain values to be inserted. Typically, the item of instance data 829 represents a potential recipient of an instance 845 and includes personal information about the recipient in fields 879. The fields may also include information 881 from which the recipient's membership in groups which may have versions associated with them can be determined. Thus, given an ID 877 for an item of instance data, system 801 can produce an instance 845 which is individualized both with regard to personal information for the recipient and with regard to groups that the recipient may belong to.

A version data tag 835 is more complex. It indicates an area in tagged base content 831 which is affected by insertion of the contents of an item of version data 825. Version data tag 835 has a start marker 859, which marks the start of the area, and an end marker 860, which marks the end of the area. Both start and end markers include a tag type 851, an identifier 853 for the version, and an identifier 855 which locates the item of version data represented by the tag in database 821. If the contents of the item of version data is to be simply inserted into the instance, the end marker immediately follows the start marker in the tagged base content; if the contents are to replace part of the contents of the tagged base document, start marker 859 marks the start of the contents to be replaced and end marker 860 marks the end of the contents to be replaced, as shown at 857. An item of version data 825 contains a version data identifier (vdid) 855 which permits location of the version data in database, a version identifier (vid) which identifies the version, and the contents 865 of the version data item.

Some embodiments of system 801 may be used only to create different versions of tagged base content 831. In such embodiments, tagged base content may include only instance data tags 837, GUI 811 may include only version data GUI 807, and individualization information 822 may include only version information 823. Plugin 819 would cause display 806 to display either base content 833 or the version currently specified by version data GUI 807.

Operation of System 801

System 801 has three basic modes of operation: setup, editing, and instance production. Setup must be done before the other modes. In editing mode, individualization plugin 819 provides a view of tagged base content 831 to display 806 which corresponds to the kind of editing the content provider is doing, as shown by arrow 881. The view changes to reflect the content provider's edits to tagged base content 831. There are two editing modes: base content editing, in which base content 833 is edited, and tag editing. In tag editing, the content developer inserts or modifies tags, using version data GUI 807 or instance data GUI 809 as required by the type of the tag being inserted or modified. In instance production, plugin 819 produces instances 845 for items of instance data 829 and outputs them to an output device, as shown by arrow 883.

Setup

The information required to set up individualization plugin 819 to permit insertion of tags for a particular set of versions and a particular set of fields 879 of instance data is contained in GUI XML 815. When plugin 819 interprets the XML, the result is the version data GUI 807 and the instance data GUI 809 required for the particular set of versions and the particular set of fields.

Base Content Editing

Individualization GUI 811 permits the content developer to indicate that he or she wishes to enter a base content editing mode. In this mode, plugin 819 causes base content 833 to be displayed in content display 806 and the content developer uses editing program 817 to create or edit base content 833. The content developer can edit base content 833 using program 817 until he or she indicates a change of mode.

Tag Editing

How tag editing is done in a preferred embodiment depends on whether what are being added or edited are instance data tags 837 or version data tags 839. In the case of the instance tags, individualization plugin 819 causes content display 806 to display instance 845 for a particular recipient. The content developer navigates in displayed instance 845 to the location in tagged base content 831 at which the instance data tag is to be inserted and uses GUI 809 to specify the field of the instance data item 829 representing the recipient for whom the content is being individualized which contains the value that is to be inserted in the recipient's instance 845. The content developer then uses GUI 809 to indicate that an instance data tag 837 indicating the specified field is to be inserted at the point to which the content developer has navigated. Plugin 819 then displays instance 845 with the value of the specified field at the position of the tag.

With version data tags, the content developer uses version data GUI 807 to indicate which version the content developer is editing. Individualization plugin 819 responds by displaying an instance 845 in content display 806 for a recipient that is related to that version of the tagged base content. In a preferred embodiment, once that is done, an editing operation which is done by the content developer using content editing program 817 automatically results in insertion of a version data tag 835 for the version into tagged base content 831 and the creation of an item of version data 825 for the version that contains data resulting from the editing operation in database 821. The data that results from the editing operation is thereby associated with the version.

Instance Production

In producing an instance 845, individualization plugin 819 resolves all of the tags 835 in tagged base content 831 which are relevant to that instance 845. In resolving a tag, the plugin replaces the tag with the data which the tag represents, as shown at 867. In order to produce an instance 845, plugin 819 must consequently have access to the data which the tag represents.

In the simplest case, plugin 819 receives a specification of an identifier for an item of instance data 829 and then uses the values of the fields 879 to resolve the instance data tags 837 and uses the version specified at 881 in the preferred embodiment's item of instance data 829 and vid 853 in the version data ids 855 in those tags to determine which version data tags to resolve and vdid 855 in each of the tags to obtain the information from the items of version data 825 required to resolve the tags. In a preferred embodiment, instance data GUI 809 permits the content developer to identify an item of instance data 829, and plugin 819 responds to the identification by using the item of instance data to resolve the tags as just described. Editing program 817 displays the instance 845 so that the content developer can see the effects of the tags he or she has inserted on the base content. When it is time to produce a set of instances 845, for example for a mailing, a query on instance information 827 can produce a list of instance data items 829, and an instance can be produced as described above for each instance data item on the list.

Of course, the information needed to resolve the instance data tags 837 and determine which set of version data tags to resolve may be obtained from sources other than database 821. For example, in an interactive Web application, the information needed for the instance data and to determine which version applies may be obtained from the individual with whom the application is interacting.

It should be noted here that because plugin 819 produces the instances 845 on the fly from tagged base content 831 and the version information 823 and instance information 827, no instances 845 need be kept in system 801. The only file required to produce the instances is tagged base content 831. Further, tagged base content 831 may contain version data tags 839 for as many different versions of base data 833 as are required.

### Details of a Preferred Embodiment of System 801

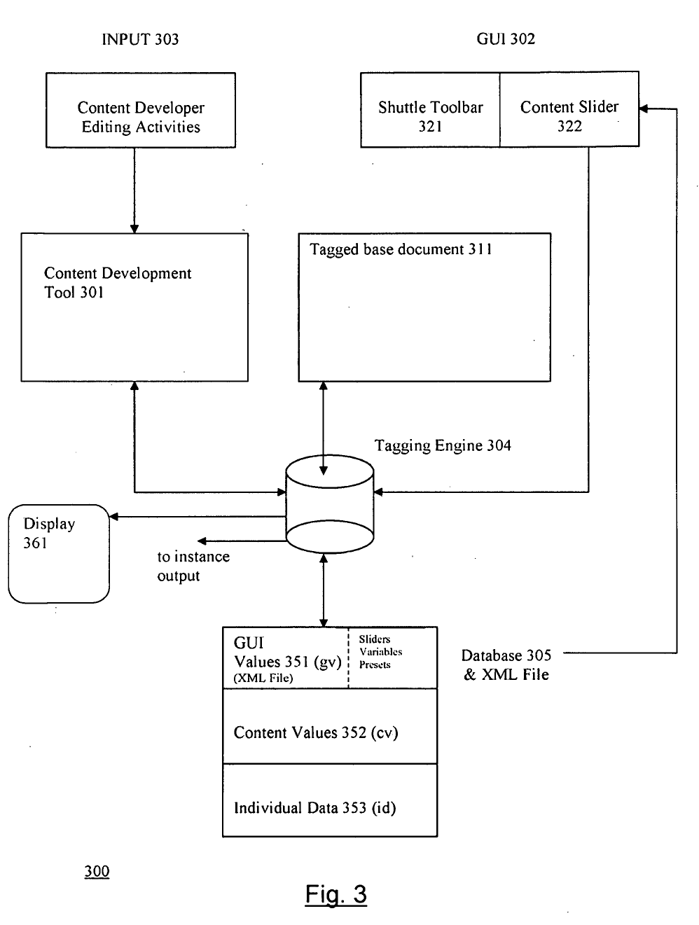

Overview of the Preferred Embodiment: FIG. 3

FIG. 3 shows a system 300 which is a presently preferred embodiment of system 801. Base document 301 implements tagged base content 831, content development tool 301 implements content editing program 813, tagging engine 304 implements plugin 819, display 361 implements display 806, input 303 implements standard editing GUI 805, GUI 302 implements individualization GUI 811, shuttle toolbar 321 implements instance data GUI 809, content slider 322 implements version data GUI 809, and database 305 implements individualization database 821. In database 305, GUI values 351 implement GUI XML 815, content values 352 implement version information 823, and individual data 353 implements instance information 827. Content Development Tool 301 may be any available tool for content editing. The individualized output is produced by interactions between Database 305, Tagging Engine 304 and Content Slider 322.

After creating base content 833, the content developer uses the provided GUI 302 mechanisms to create a piece of individualized content, that is, to add variables, add content, and otherwise modify document 833 to produce document 311 while the Content Sliders 322 are manipulated. The individualized output is displayed in display 361 and can be used to preview individualized content using the Shuttle Toolbar 321. The same GUI mechanisms can be used by people other than the content creator to view the content in any of the different modes or to create instances of the content the individuals in the database.

Base content 833 defined in system 300 may be modified at any time, as may be the individualized content represented by tags 835. Of particular note in system 301 is that all variable manipulations, Base Document manipulations and individualized content modifications are achieved through graphical user interfaces; consequently, no programming experience or knowledge of the syntax of the tags or of rules is required. At any time a Content Developer may examine the entire set of data available in the connected database using the Shuttle Toolbar 321, allowing a Content Developer to visually inspect all individualized pieces of content.

Database 305 has three major components: GUI Values 351, Content Values 352, and Individual Data 353. GUI values are created and used by the Tagging Engine 304 to make GUIs 321 and 322. Content Values consist of just that, pieces of content a content developer has used to individualize a document. Individual Data is generally a customer database which has entries for the recipients of the individualized content. Information from these entries is the source of the values represented by instance data tags in instances produced for a given customer and also indicates which version the given customer is to receive.

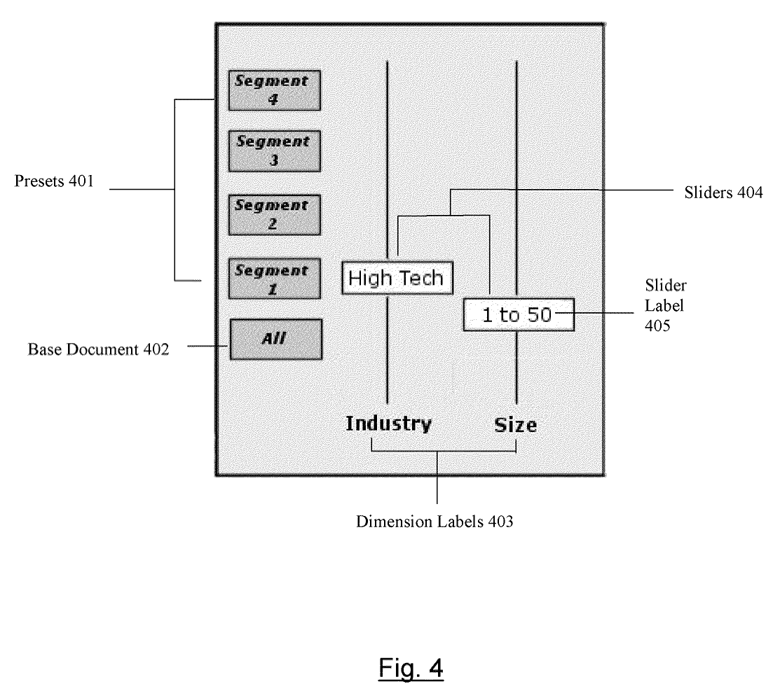

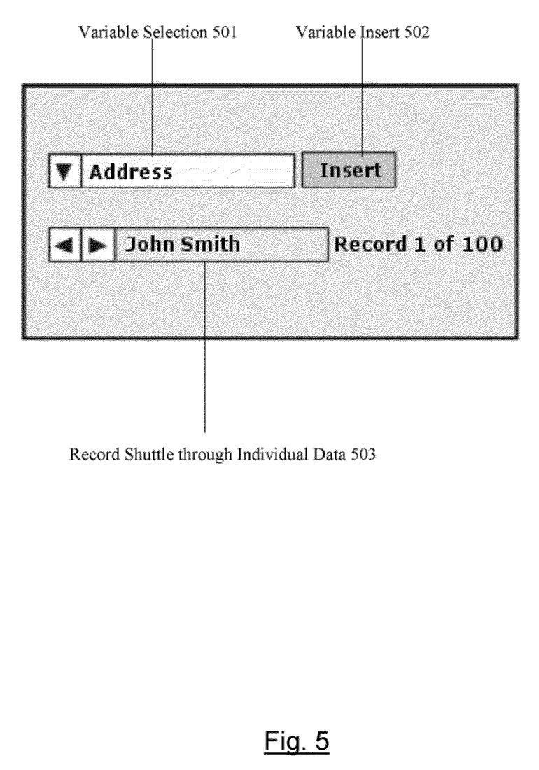

Details of GUI 302: FIGS. 4 and 5

Content Slider 303 is shown in detail in FIG. 4. Content Slider 322 consists of four main elements: Preset Buttons 401, Base Document editing mode indicator 402, Dimension Labels 403 and Sliders 404. Beginning with sliders 404, there may be one or more sliders 404 in GUI 303. Each individual slider may be set to a number of discrete positions; the label on a slider 404 indicates the discrete position to which the slider is currently set. The current settings of all of sliders 404 identify a version in tagged base content 833. The set of discrete values which a given slider may specify represents what will be termed here a dimension of the version represented by the settings of all of the sliders. Each Dimension label 403 indicates the dimension of the values set by the slider.

In system 300, Dimension labels 403 are the names of columns in individual data 353. Each of these columns has a set of discrete values defined for it and these values are the values to which the slider corresponding to the column may be set. The value currently selected by the slider's position appears on the slider's label 405. By setting one or more of the sliders to discrete values in the preferred embodiment, the content provider not only identifies a version of tagged base content 831, but also a group of recipients. An instance 845 for each member of the group identified by the slider settings will have the version identified by the slider settings. By relating sets of values in individual data 353 to groups of recipients and to versions of tagged base content 831, the sliders fill the function of rules in prior-art systems without requiring that the convent developer either understand the Boolean logic or the formal syntax required for writing rules.

For example, the discrete.values of the Industry slider indicate a number of industries as indicated by label 405; the slider is currently set to High Tech. Similarly, the discrete values of the Size slider indicate the size of the business in terms of number of employees; the slider is currently set to 1 to 50. The version of tagged base content 831 specified by the slider settings of FIG. 4 is thus the version of the content which is intended for the group of recipients that work in high tech industries which have no more than 50 employees.

It should be pointed out here that any GUI which permits the content developer to select discrete values from among one or more dimensions may be used in the same fashion as the sliders to relate a version of tagged base content 831 to a group of recipients. For example, each dimension may be represented by a list of check boxes for the dimension's potential values; in such an embodiment, the content developer would check a box in each of the dimensions needed to define the group of recipients. In other embodiments, one or more dimensions may not be based on values that are part of the recipient's instance data 829. One example of this is if the version the recipient is to receive depends on the time of year; another is if the version depends on a particular product. For example, if the versions were intended for different seasons of the year, there could be a seasons dimension. In that case, of course, resolution of the version tags would require a value for the current season. In still other embodiments, each version may have a label, and the version's label may be included in each recipient's item of instance data 829.

Each Preset Button 401 represent a set of settings of the sliders 404 in interface 322; as such, each preset button 401 represents a version and, in the preferred embodiment, a group of recipients. To obtain the slider settings for a given version, one simply pushes the preset button for the version. All button 402 indicates that system 300 is operating in base content editing mode; when this is the case, all of the sliders 404 are set to a base level and the labels 405 on the sliders indicate All. The number of sliders in interface 322, the slider labels 405, the labels 403 indicating dimensions, the number of presets 301, their labels, and the slider settings for the versions they represent are all defined in GUI XML file 351. The content creator may create XML file 351 him- or herself using plugin 819 or may receive a complete or partially complete XML file from an external source. The use of a predefined GUI XML file aids in the achievement of conformity among different content developers and between contents belonging to different media.

Shuttle Toolbar 321 is shown in FIG. 5. Shuttle Toolbar 321 does two things: it permits the content developer to insert instance data tags 837 into tagged base content 833 and to select an individual for which tagging engine 304 is to create an instance 845 of the individualized tagged base content and cause content development tool 301 to display the instance 845. Variable Selection dropdown 501 and Variable Insert button 502 are used to create and insert an instance data tag 837 into tagged base content 831. Dropdown 501 is a list of the columns of the records in individual data 353 whose values may be represented by instance data tags. To create an instance data tag 837, the user employs content development tool 301 to navigate to the location in tagged base content 831 at which the tag 837 is to be inserted; then the user selects the column that will contain the desired value from the dropdown list 501 and hits variable insert button 502. Tagging engine 304 responds by inserting a tag 836 which specifies the column at the location and generating a display in display 361 which shows the value represented by the tag for the recipient currently indicated by the shuttle. The value may be distinguished in the display to indicate that it is an instance data value.

Record shuttle 503 contains an entry which represents each record in individual data 353. As shown in FIG. 5, the entry is typically the name of the individual the record belongs to. The content developer uses the arrows at the left of shuttle 503 to move through the entries until he or she finds the one he or she wants. The content developer than clicks on the entry. In response to the click, tagging engine 304 responds by setting sliders 404 to the version specified in the record specified by the entry and resolving tags in tagged base content 831 as required to produce instance 845 for that person.

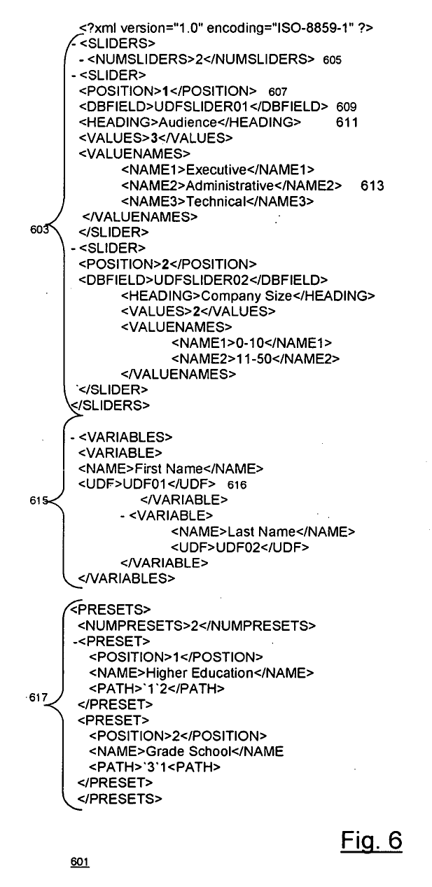

Definitions of GUI Values 351: FIG. 6

FIG. 6 is an example of an XML Document 601 utilized by Tagging Engine 304 to define GUI values 351 for GUIs 321 and 322. The XML Document consists of 3 main parts: A section 603 which defines Sliders in GUI 322, a section 615 which defines drop-down list 501 in FIG. 5, and a section 617 which defines the preset buttons 401 in GUI 322. The XML is exemplary only. It does not define the actual interfaces of FIGS. 4 and 5. Sliders section 603 consists of a value 605 for the number of sliders and sub-sections for each Individual Slider. The Individual Slider sub-sections contain data 615 about the slider's position in the GUI, its dimension label 403 (611), the number of values the slider can be set to, the names 613 for each of these values, and the slider's link 609 to the column for the slider's dimension in the records of individual data 353. Section 615 for drop-down list 501 contains a section for each entry in the list and stores the name of the column of individual data 353 the data specified by the list will come from as well as a link 616 to that column. Presets section 617 consists of: a value for the number of presets and a sub-section for each individual preset. The individual Preset subsection consists of the position a preset will take in the GUI, allowing a user to leave presets blank or shuffle the preset placement around, the name of the preset and a “path” for the sliders. The path represents the set of slider settings which the preset button represents. The “path” is a sequence of values preceded by ‘ characters, with the values having the same order as the sliders and each value representing the slider's position in the version represented by the preset. As will be seen in more detail in the following, the preferred embodiment employs paths as version identifiers in the preferred embodiment's version data tags and version data items. Other embodiments may employ other techniques for identifying versions and/or relating a slider position or its equivalent with regard to a value in a dimension to a version.

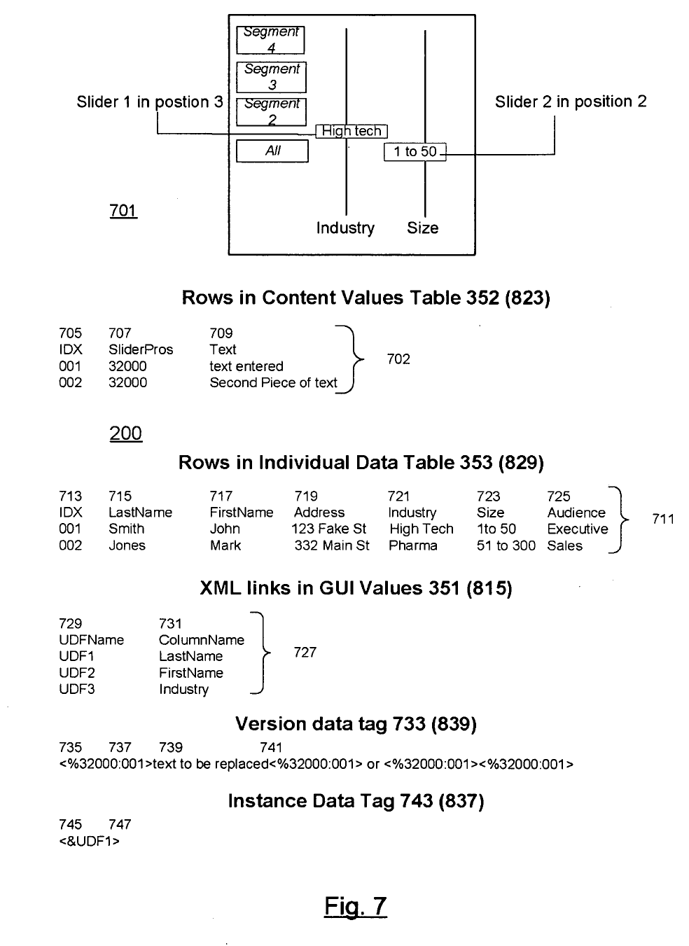

Details of Individualization Information 822 and Tags 835 in the Presently-Preferred Environment: FIG. 7

FIG. 7 shows details of the implementation of individualization information 822 and tags 835 in a preferred embodiment. The context for the individualization information 822 and tags 835 is provided by the settings of the Industry slider and Size sliders shown at 701. Content values table 352 is the implementation of version information 823 in the presently-preferred embodiment. Each row 702(i) in table 352 has three fields: field 705, which is the rowid for the row in the table, field 707, which is the slider positions, expressed as a five-digit value in which the first digit specifies the position of slider 1, the second the position of slider 2, and so on. Field 709 contains the text, if any, represented by the tag. The text may include instance data tags 837. In the presently-preferred embodiment, when plugin 819 displays the entry 601(i)'s text, it resolves any instance data tags in the text.

Individual data table 353 is the presently-preferred embodiment's implementation of instance information 827. Each row 711(i) in table 353 has as many columns as are required for a recipient's personal information. Column 713 is the row identifier for the row; columns 715-719 contain the recipient's name and address; columns 721-725 contain information identifying categories of recipients which the recipient belongs to; as may be seen at 701, the names of columns 721 and 723 are used to identify the sliders in FIG. 701 and the sliders are set to possible values of those columns. As set at 701, the sliders identify the group of recipients that the recipient represented by the row indexed by 001 belongs to, namely the group of recipients that has the value High Tech in field 721 and the value 1 to 50 in field 723.

XML links 727 in GUI values 351 relate values of instance data tags to columns of individual data table 353. Thus, the instance tag value UDF1 in column 729 is related by column 731 to the column named LastName of individual data table 353; that column contains the last names of the recipients, and consequently, when individualization plugin 819 produces an instance 845 for a recipient, the tag value UDF1 will be replaced by the last name of the recipient for which plugin 819 is producing the instance 845.

Version data tag 733, which implements version data tag 839, includes a tag type identifier 735, a slider settings identifier 737 which identifies the slider settings for the version the tag belongs to, and the rowid 739 for the row in content values table 353 which contains the data represented by the tag. If the editing operation that created the tag involves replacement of text, the text that was replaced is contained in the tag at 741.

Instance data tag 743 contains tag type identifier 745 and tag value 747, which specifies the column of the individual data table record 711 for the recipient for which instance 845 is being made from which the instance data represented by the tag is to be taken. Here, as may be seen from links 351, the tag represents the recipient's last name.

Example Editing Scenario: FIG. 2

FIG. 2 shows an example editing scenario at 201. In the scenario, the content provider first edits base content 833 (203), then edits a version (205), and finally adds instance data to the version (207). For each stage of the scenario, the figure shows how the sliders 404 are set, what the content provider does, what the content provider sees in display 806, and what changes result from the content provider's activity in tagged base content 831 and in version information 823.

At 203, the content provider first sets all sliders 404 to All to indicate that he or she is editing in base document editing mode. Plugin 819 displays base content 833 in display 806. The content provider uses standard content editing GUI 805 to navigate to the location which he or she wishes to edit in base content 833. Then the content provider uses standard content editing GUI 805 to enter the text “Welcome to our broad based customer rewards program.” Plugin 819 displays base content 833 as edited in display 806 and causes the text to be added to base content 833 in tagged base content 831. Since no version data tag 839 has been added and no version information has been modified, nothing is stored in version information 823.

At 205, the content provider sets the Industry slider to position 3, at which it specifies High Tech, the Co. Size slider to position 1, at which it specifies 1 to 50, and the Audience slider to position 4, at which it specifies Executive. The version specified by the slider settings is the one for recipients whose fields 721, 723, and 725 in their individual data table rows 711 indicate that they are executives in high tech firms having 50 or fewer employees. That done, plugin 819 displays an instance 845 of tagged base content 831 in display 806 in which the tags for the High Tech, 1 to 150, Executive version have been resolved. The content provider then uses editing GUI 805 to navigate to the position of “broad based” in display 806 and replace it with “small business”. In response to this editing operation, plugin 819 creates a row in content value table 352 which contains the slider positions for the version and the new version data “small business” and a version data tag 733 which specifies the slider positions, the data “broad based” being replaced, and the rowid of the content value table. The second edit, which inserts “specifically tailored”, is treated similarly.

At 207, the content provider continues editing the High Tech, 1 to 150, Executive version. Now he/she personalizes the version by using GUI 805 to navigate to the position ahead of “Welcome” in display 806, using the GUI of FIG. 5 to insert an instance data tag 839 which specifies the recipient's first name ahead of “Welcome” and using GUI 805 to change the “W” of “Welcome” to “w”. In response, plugin 819 responds as described above. The version data tag 733 for the change specifies the “W” that is replaced and the row in content values table 352 for the version data tag includes the inserted instance data tag and the “w”. Tagging engine 304 displays an instance 845 of the version in content display 361 that reflects the change.

### CONCLUSION

The foregoing Detailed Description has disclosed Applicants' techniques and how to use them to those skilled in the relevant technologies and has further disclosed the best mode presently known to the inventors for carrying out the techniques. As will be immediately apparent to those skilled in the relevant technologies, there are many ways other than the ones disclosed herein of implementing the techniques. For example, any form of the individualization GUI may be used which provides the information that is needed for the individualization system to determine the kind and contents of a tag. The individualization GUI and the information the content provider must provide to it will of course be determined to some extent by the kind of content being personalized and the kind of content editing interface being used. The same is the case with the displays which the individualization system produces in the content display. Further, the syntax and or contents of the tags may vary from implementation to implementation, as may the manner in which individualization database 821 is implemented. In principle, any arrangement which permitted storage and retrieval of items of individualization information could be used. Finally, while implementing the individualization system by means of a plugin for a standard content editor offers many advantages, the system could also be implemented by replacing the plugin with a built-in component of the content editor.

For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

1. A method of making a tag that represents an individualization data item for individualizing content and inserting the tag into a location in the content at which the individualization data item is to occur in the individualized content, the method being practiced in a content individualization system which has a content editing GUI and a tag making GUI and the method comprising
the steps performed by a user of the content individualization system of
using the content editing GUI to navigate to the location in the content and
using the tag making GUI to identify the individualization data; and
the step performed by the content individualization system in response to the user steps of
creating the tag that represents the identified individualization data at the location in the content, whereby the user is able to make and insert the tag without knowledge of the syntax which the individualization system requires for the tag.

2. The method of making a tag set forth in claim 1 wherein:
the individualization data item is obtained from a record that represents a recipient of the individualized content;
the tag making GUI permits selection of a field name for a field in the record;
in the step of using the tag making GUI, the user selects the field name; and
in the step of creating the tag, the tag includes an identifier for the field having the selected field name.

3. The method of making a tag set forth in claim 2 wherein:
the tag making GUI further permits an indication that the tag be created;
in the step of using the tag making GUI, the user further makes the indication after selecting the field name; and
the content individualization system creates the tag in response to the indication.

4. The method of making a tag set forth in claim 1 wherein:
the content to be individualized includes a plurality of versions;
a version of the plurality is associated with a set of values belonging to a plurality of sets of values;
the tag making GUI permits indication of a particular set of the values;
in the step of using the tag making GUI, indicating the particular set of values; and
when the particular set of values has been indicated, the content individualization system responds thereto by responding to an indication of a content editing operation in the content editing GUI by inserting a tag at the location of the content editing operation that associates a result of the content editing operation with the particular version associated with the indicated set of values.

5. The method of making a tag set forth in claim 4 wherein:
responding to the indication of the content editing operation further includes creating a record in a database system that contains the associated result of the content editing operation and including an identifier for the created record in the tag.

6. The method of making a tag set forth in claim 5 wherein:
when the result of the content editing operation includes replacement of content, the inserted tag further includes the replaced content and the created record includes the replacing content.

7. The method of making a tag set forth in claim 4 wherein:
the sets of values are sets of values of fields in a record that represents a recipient of the individualized content, the fields indicating characteristics of the recipient that are significant for determining which of the content versions applies to the recipient.

8. The method of making a tag set forth in claim 4 further comprising the step performed by the content individualization system of:
creating a display upon which the editing operation is indicated in the content editing GUI by resolving the tags associated with the particular set of values.

9. The method of making a tag set forth in claim 4 wherein:
the content includes content which is common to all of the versions;
the tag making GUI permits an indication that the common content is to be edited; and
when the tag making GUI so indicates, the content individualization system performs the editing operation on the common content without inserting a tag.

10. The method of making a tag set forth in claim 9 wherein:
the content individualization system creates the display upon which the editing operation is indicated in the content editing GUI by neither displaying nor resolving the tags.

11. The method of making a tag set forth in claim 1 wherein:
the content to be individualized includes a plurality of versions;
the individualization data includes
instance individualization data that is values obtained from a record that represents a recipient of the content and
version individualization data that is content that is included only in a particular version of the plurality of versions;
the tag making GUI includes
an instance data tag making GUI that the user employs to create tags representing instance data and
a version data tag making GUI that the user employs to create tags representing content data belonging to a particular version of the content.

12. The method of making a tag set forth in claim 11 wherein:
a version of the data is associated with a set of values that is obtained from a recipient record;
the tag making GUI further includes
a recipient indicator that indicates a recipient for the individualized content; and
the content individualization system performs the step of:
creating a display upon which the instance data tags and the version data tags are resolved using values obtained from the recipient record for the recipient indicated by the recipient indicator.

13. A data storage device accessible to a processor, the data storage device being characterized in that:
the data storage device contains code which, when executed by the processor, implements the method set forth in claim 1.

14. A method employed with content that has a plurality of versions of editing a particular version of the plurality using a content processor, the method comprising the steps performed in the content processor of:
responding to a selection in a version selection GUI of a set of values which distinguish the particular version and input specifying an editing operation by performing the editing operation on the content; and
associating data resulting from the editing operation with the distinguished particular version.

15. A method of displaying content that has a plurality of versions and has base content that is included in all the versions, the method comprising the steps of:
when user input to a GUI indicates the base content, displaying the base content; and
when user input to a GUI indicates one of the plurality of versions, displaying the version with the included base content.

16. A representation of content which includes version content for a plurality of versions, the representation comprising:
a representation of the common content; and
in the representation of the common content, a distinct set of version tags for each of the versions of the plurality, a version tag that represents an item of version data belonging to a particular version of the plurality being located in the representation of the content where the represented item of version data is to be inserted and including
a version identifier that identifies the particular version and
an item of version content identifier that identifies a source for the represented item of version data which is external to the representation of the content.
